(19) United States
(12) Patent Application Publication
(10) Pub. No.: US 2005/0016232 A1
(43) Pub. Date: Jan. 27, 2005

(54) Anti-theft lock assembly

(75) Inventor: Thomas Charles Baloga, Fort Mill, SC (US)

Correspondence Address: Adams Evans P.A., 2180 Two Wachovia Center, 301 S. Tryon Street, Charlotte, NC, 28282, US

(73) Assignee: Britax Child Safety Inc., Charlotte, NC (US)

(21) Appl. No.: 10/877,372

(22) Filed: Jun. 25, 2004

Related U.S. Application Data
(60) Provisional application No. 60/484,151, filed on Jul. 1, 2003.

(51) Int. Cl. E05B 37/06

(52) U.S. Cl. 70/286

(57) ABSTRACT

An anti-theft lock assembly for securing a mobile object such as a baby carriage to an immovable structure such as a pole. The lock assembly includes a lock housing adapted for being securely attached to the carriage, and a lock mechanism positioned in the lock housing for being selectively moved between an engaged locked position and a disengaged unlocked position by a user having access means to operate the lock mechanism. An elongate cable is biased into a normally retracted position by a fixed end thereof in the lock housing. The cable is extensible for being extended around the pole. The cable has a head on a free end thereof for engaging with the lock mechanism in the engaged locked position for encircling and securing the lock assembly and the carriage secured thereto to the pole.

This application claims priority from Provisional Patent Application Ser. No. 60/484,151, filed Jul. 1, 2003.

### TECHNICAL FIELD AND BACKGROUND OF THE INVENTION

This invention relates to an anti-theft lock assembly for mobile objects, for example, a baby carriage such as a pram, pushchair or stroller, and also to a baby carriage incorporating such an anti-theft lock assembly. The term “mobile object” as used in this application includes not only baby carriages but other vehicles such as wagons, tricycles, bicycles, motor scooters and the like, and the term “baby” is used in the broad sense to mean a child sufficiently small to be placed in and pushed about in the carriage.

Frequently, when a parent wishes to take a young child into a building, it is necessary for the parent to leave the baby carriage unattended outside the building. For example, when shopping at a supermarket, such a parent may transfer the child to a child seat in a supermarket cart and leave the carriage outside the supermarket or just inside the entrance. In these circumstances, the unattended baby carriage is vulnerable to theft.

### SUMMARY OF THE INVENTION

Therefore, it is an object of the invention to provide an object of the invention to provide an anti-theft device for a mobile object, such as a baby carriage.

According to the invention, an anti-theft device comprises a housing adapted to be secured to a baby carriage, a lock mechanism positioned in the housing, and a latch formation adapted to be insertable into the lock and to be secured therein and a cable having a first end secured to the body and a second end secured to the latch formation. The lock may be arranged to be operated by a user having access means to operate the lock, such as a removable key.

Alternatively, the access means may be a combination lock arranged to be operated by utilizing a code comprising a plurality of numbers or other characters.

Preferably, the body comprises a housing containing a retractor and the first end of the cable is secured to the retractor for protraction therefrom. The term “cable” is used broadly to include anywire, rope, chain, cord or combination thereof that is sufficiently cut and break-resistant to deter theft.

The retractor may include a manually operable brake for blocking protraction and retraction of the cable therefrom. Operation of the brake may be linked to the lock so as to prevent release of the brake when the latch formation is engaged with the lock.

The invention also includes a baby carriage having a locking assembly of the type described above.

The anti-theft lock assembly for securing a mobile object to an immovable structure further comprises a lock housing adapted for being securely attached to the mobile object, and a lock mechanism positioned in the lock housing for being selectively moved between an engaged locked position and a disengaged unlocked position by a user having access means to operate the lock mechanism. An elongate cable is biased into a normally retracted position by a fixed end thereof in the lock housing and is extensible for being extended around the immovable structure. The cable has a head on a free end thereof for engaging with the lock mechanism in the engaged locked position for encircling and securing the lock assembly and the mobile object secured thereto to the immovable structure.

According to one preferred embodiment of the invention, the lock mechanism comprises a combination lock having a plurality of coded thumb wheels for being moved to their respective unlocked positions by the user.

According to another preferred embodiment of the invention, the lock mechanism further comprises a bolt biased into a locking position and a laterally extending recess for receiving a plunger carried on a free end of the cable. The cable has an enlarged, mushroom-like head for being inserted into the recess and engaged by a shoulder on a wall of the recess.

According to yet another preferred embodiment of the invention, the fixed end of the cable is wound onto a spool carried by the housing, and the spool is mounted on a shaft biased to retract the cable and wind the cable onto the spool.

Preferably, the spool comprises side flanges having radially extending teeth on the respective peripheries thereof defining a plurality of notches. A pawl is mounted in the housing and biased into an engaged position in one of the notches. A pushbutton is accessible through an opening in the housing for being depressed by a user to disengage the pawl from the notches.

According to yet another preferred embodiment of the invention, a cavity is positioned in the housing between the bolt and the pushbutton. A piston is mounted in the cavity and is engagable with a heel of the pawl for maintaining the pawl in its engaged position. An opposing end of the piston projects through a hole in the bolt and into a recess therein. A spring engages a flange on the piston and normally biases the -piston out of engagement with the heel. The plunger, when inserted into the recess, is adapted for pushing the piston into its engaged position with the heel, thus retaining the pawl in its engaged position while the plunger is engaged in the bolt.

According to yet another preferred embodiment of the invention, the mobile object comprises a baby carriage.

According to yet another preferred embodiment of the invention, a baby carriage is provided, comprising a carriage chassis mounted on wheels and to which is attached a baby-receiving and carrying support. An anti-theft lock is secured to the chassis for securing the chassis to an immovable structure such as a pole. The lock assembly comprises a lock housing adapted for being securely attached to the chassis. A lock mechanism is positioned in the lock housing for being selectively moved between an engaged locked position and a disengaged unlocked position by a user having access means to operate the lock mechanism. An elongate cable is biased into a normally retracted position by a fixed end thereof in the lock housing. The cable is extensible from the housing for being extended around the immovable structure, the cable having a head on a free end thereof for engaging with the lock mechanism in the engaged locked position for encircling and securing the lock assembly and the carriage secured thereto to the immovable structure.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is an environmental view of a baby carriage protected by an anti-theft lock according to an embodiment of the invention;

FIG. 2 is a side view of a locking assembly in accordance with the invention, having a cover of its housing removed;

FIG. 3 is a cross-sectional view taken on the line 3-3 in FIG. 2; and

FIG. 4 is a side view, similar to FIG. 2, of a second embodiment of the invention.

### DESCRIPTION OF THE PREFERRED EMBODIMENT AND BEST MODE

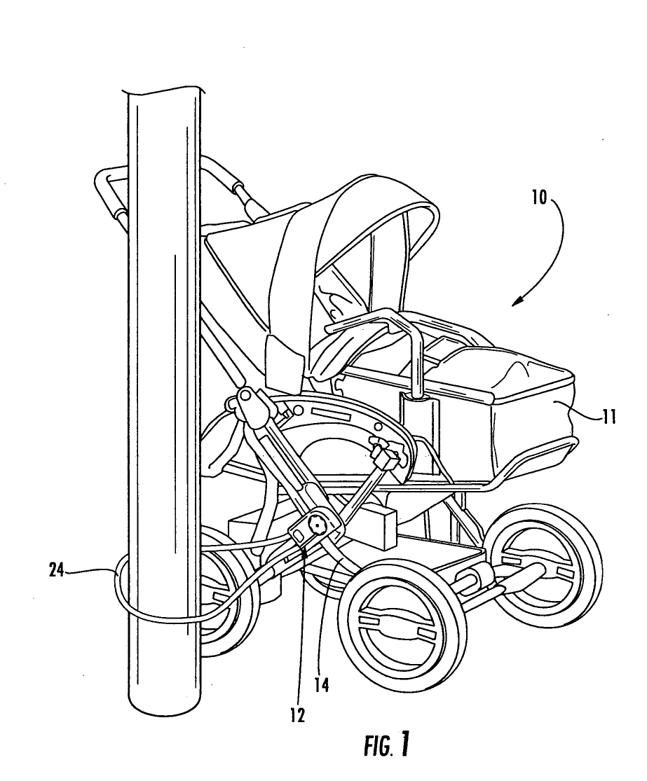

Referring now specifically to the drawings, a anti-theft lock in place on a baby carriage according to the present invention is illustrated in FIG. 1 and shown generally at reference numeral 10. The carriage 11 is shown secured to a pole by an anti-theft lock 12.

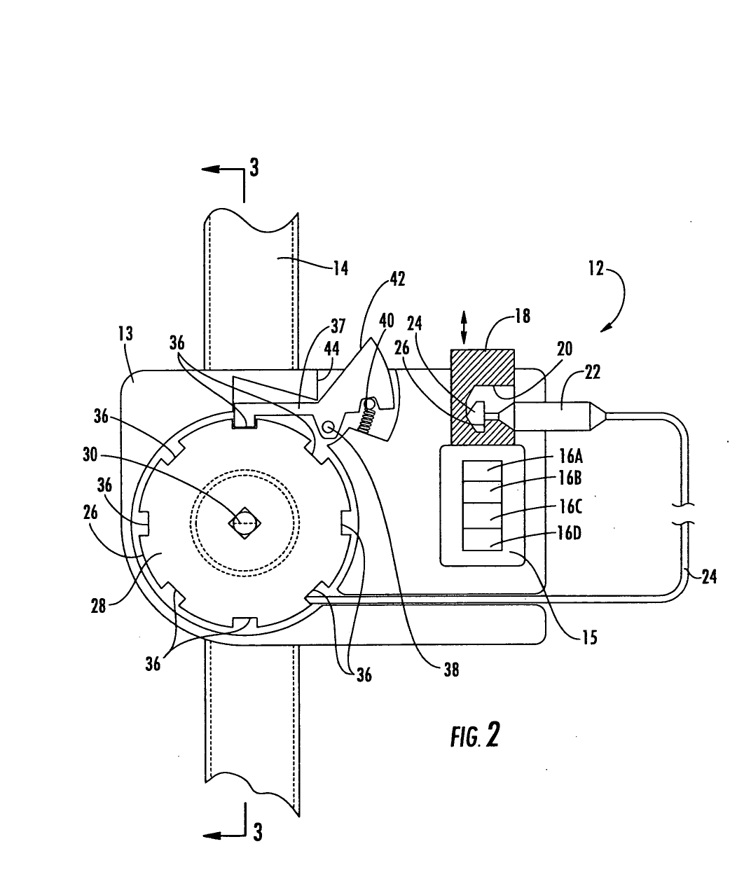

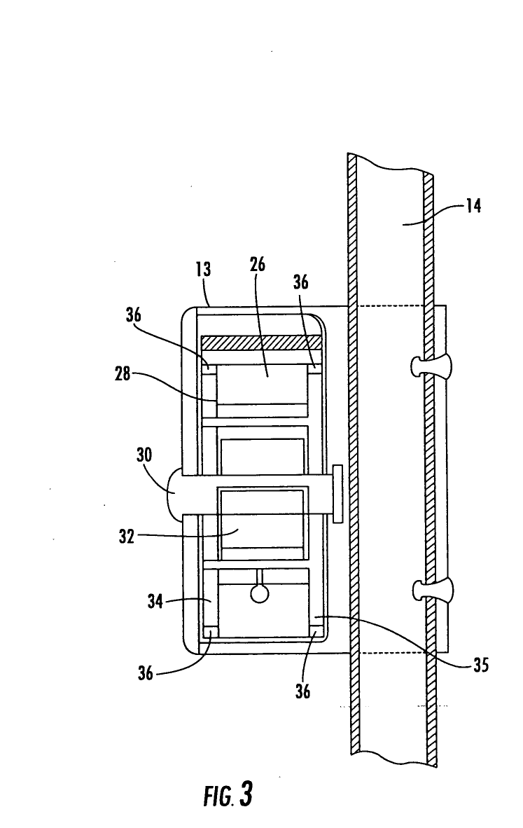

Referring now to FIGS. 2 and 3, the lock 12 is more specifically shown, and includes a housing 13 which is secured, for example by clamps, to a tubular structural member 14 of the carriage 11.

The housing 13 contains a combination lock 15 having four thumb wheels 16A-D for selecting a preset combination of numbers, letters or other symbols, and a bolt 18 that is biased upwardly (as viewed in FIG. 1) by a biasing means such as a compression spring (not shown). The bolt 18 contains a laterally extending recess 20 for receiving a plunger 22 having an enlarged, mushroom-like head 24 on one end. The head 24 is arranged to be engaged by a shoulder 26 on the lower wall of the recess 20 defined by the bolt 18.

When the thumb wheels 16 are set to the required combination, the bolt 18 can be pressed downwardly so as to disengage the head 24 from the shoulder 26, thus allowing the plunger 22 to be removed from the recess 20.

The other end of the plunger 22 is connected to one end of a flexible cable 24, the other end of which is wound onto a cylindrical surface 26 of a spool 28. The spool 28 is journaled in the housing 13 on a shaft 30. A coiled leaf spring 32 is secured to the shaft 30 and serves to bias the spool 28 in the direction to retract the cable 24 and wind it onto the spool 28. The spool 28 has side flanges 34 and 35 with radially-extending notches 36 on the peripheries thereof that can be engaged by a pawl 37. The pawl 37 is mounted in the housing 13 on a pivot pin 38 and biased into an engaged position by a compression spring 40. The pawl 37 has a pushbutton 42 that is accessible through an opening 44 in the top surface of the housing 13 so that it can be depressed by a user's finger to cause disengagement of the pawl 37 from the notches 36 of the flanges 34 and 35.

In use, the pushbutton 42 is depressed to disengage the pawl 37 and a sufficient length of the cable 24 is pulled off the spool 28 to reach round a pole as shown in FIG. 1, a railing, street lamp standard or other suitable fixed object. The plunger 22 is then inserted into the recess 20 in the bolt 18 so that the sloping edge of head 24 engages the shoulder 26 of the bolt 18, whereupon the bolt 18 snaps back up into its locked position. The pushbutton 42 on the pawl 37 is then depressed. The cable 24 is then wound onto the spool 28 until the pawl 37 engages in one of the notches 36. The carriage 11 is then secured to the pole. The carriage 11 can thus only be released by someone who knows the combination of the lock 11.

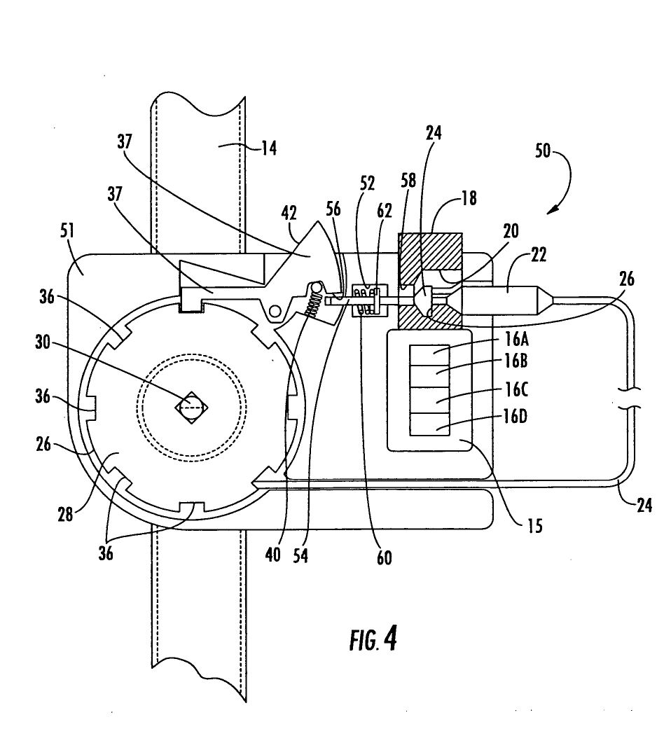

Referring now to FIG. 4, an alternative embodiment of the lock is shown at reference numeral 50. Components of the lock 50 that are identical with the corresponding components of the lock 11 illustrated in FIGS. 1, 2 and 3 are denoted by the same reference numerals and are not described again in detail.

The lock 50 has a housing 51 which differs from the housing 13 of the embodiment of FIGS. 1, 2 and 3, in that housing 51 includes an additional cavity 52 between the bolt 18 and the pushbutton 42. The cavity 52 contains a piston 54, one end of which can engage under a heel 56 of the pawl 37 so as to keep the pawl 37 in its engaged position. The other end of the piston 54 projects through a hole 58 in the bolt 18 into the recess 20 therein.

A compression spring 60 engages with a flange 62 on the piston 54 so as to bias it out of the path of the heel 56 of the pawl 37. When the plunger 22 is inserted into the recess 20, it pushes the piston 54 into a position under the heel 56, thus retaining the pawl 37 in its engaged position while the plunger 22 is engaged in the bolt 18.

The hole 58 is sufficiently large to ensure that the piston 54 does not interfere with movement of the bolt 18.

An anti-theft lock and carriage with an anti-theft lock feature are described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1. An anti-theft lock assembly for securing a mobile object to an immovable structure, comprising:
(a) a lock housing adapted for being securely attached to the mobile object;
(b) a lock mechanism positioned in the lock housing for being selectively moved between an engaged locked position and a disengaged unlocked position by a user having access means to operate the lock mechanism;
(c) an elongate cable biased into a normally retracted position by a fixed end thereof in the lock housing and extensible for being extended around the immovable structure, the cable having a head on a free end thereof for engaging with the lock mechanism in the engaged locked position for encircling and securing the lock assembly and the mobile object secured thereto to the immovable structure.

2. An anti-theft lock assembly according to claim 1, wherein the lock mechanism comprises a combination lock having a plurality of coded thumb wheels for being moved to their respective unlocked positions by the user.

3. An anti-theft lock assembly according to claim 2, wherein the lock mechanism further comprises a bolt biased into a locking position and a laterally extending recess for receiving a plunger carried on a free end of the cable and having an enlarged, mushroom-like head for being inserted into the recess and engaged by a shoulder on a wall of the recess.

4. An anti-theft lock assembly according to claim 3, wherein the fixed end of the cable is wound onto a spool carried by the housing, the spool being mounted on a shaft biased to retract the cable and wind the cable onto the spool.

5. An anti-theft lock assembly according to claim 4, wherein the spool comprises:
(a) side flanges having radially extending teeth on the respective peripheries thereof defining a plurality of notches;
(b) a pawl mounted in the housing and biased into an engaged position in one of the notches;
(c) a pushbutton accessible through an opening in the housing for being depressed by a user to disengage the pawl from the notches.

6. An anti-theft lock assembly according to claim 5, and comprising:
(a) a cavity positioned in the housing between the bolt and the pushbutton;
(b) a piston, one end of which is engagable with a heel of the pawl and maintains the pawl in its engaged position;
(c) an opposing end of the piston projecting through a hole in the bolt and into a recess therein;
(d) a spring engaging a flange on the piston and normally biasing the piston out of engagement with the heel; and
(e) the plunger, when inserted into the recess, adapted for pushing the piston into its engaged position with the heel, thus retaining the pawl in its engaged position while the plunger is engaged in the bolt.

7. An anti-theft lock assembly according to claim 1, 2, 3, 4, 5 or 6, wherein the mobile object comprises a baby carriage.

8. A baby carriage, comprising:
(a) a carriage chassis mounted on wheels, to which is attached a baby-receiving and carrying support;
(a) an anti-theft lock assembly secured to the chassis for securing the carriage chassis to an immovable structure, the lock assembly comprising:
(i) a lock housing adapted for being securely attached to the chassis;
(ii) a lock mechanism positioned in the lock housing for being selectively moved between an engaged locked position and a disengaged unlocked position by a user having access means to operate the lock mechanism;
(iii) an elongate cable biased into a normally retracted position by a fixed end thereof in the lock housing and extensible for being extended around the immovable structure, the cable having a head on a free end thereof for engaging with the lock mechanism in the engaged locked position for encircling and securing the lock assembly and the carriage secured thereto to the immovable structure.

9. A baby carriage according to claim 8, wherein the lock mechanism comprises a combination lock having a plurality of coded thumb wheels for being moved by the user possessing the code to an unlocked position.

10. A baby carriage according to claim 9, wherein the lock mechanism further comprises a bolt biased into a locking position and a laterally extending recess for receiving a plunger carried on a free end of the cable and having an enlarged, mushroom-like head for being inserted into the recess and engaged by a shoulder on a wall of the recess.

11. A baby carriage according to claim 10, wherein the fixed end of the cable is wound onto a spool carried by the housing, the spool being mounted on an shaft biased to retract the cable and wind the cable onto the spool.

12. A baby carriage according to claim 11, wherein the spool comprises:
(a) side flanges having radially extending teeth on the respective peripheries thereof defining a plurality of notches;
(b) a pawl mounted in the housing and biased into an engaged position in one of the notches;
(c) a pushbutton accessible through an opening in the housing for being depressed by a user to disengage the pawl from the notches.

13. A baby carriage according to claim 12, wherein the lock assembly further comprises:
(a) a cavity positioned in the housing between the bolt and the pushbutton;
(b) a piston, one end of which is engagable with a heel of the pawl and maintains the pawl in its engaged position;
(c) an opposing end of the piston projecting through a hole in the bolt and into a recess therein;
(d) a spring engaging a flange on the piston and normally biasing the piston out of engagement with the heel; and
(e) the plunger, when inserted into the recess, adapted for pushing the piston into its engaged position with the heel, thus retaining the pawl in its engaged position while the plunger is engaged in the bolt.
